(19) United States
(12) Patent Application Publication
(10) Pub. No.: US 2022/0131832 A1
(43) Pub. Date: Apr. 28, 2022

(54) DYNAMIC NETWORK FEATURE PROCESSING DEVICE AND DYNAMIC NETWORK FEATURE PROCESSING METHOD

(71) Applicant: INSTITUTE FOR INFORMATION INDUSTRY, TAIPEI (TW)

(72) Inventors: Chia-Kang HO, Taipei (TW); Kuan-Lung HUANG, Taipei (TW); Chia-Min LAI, Taipei (TW)

(21) Appl. No.: 17/099,797

(22) Filed: Nov. 17, 2020

(30) Foreign Application Priority Data
Oct. 27, 2020 (TW) 109137311

(51) Int. Cl. H04L 29/06

(52) U.S. Cl. CPC H04L 63/0236; H04L 2463/146; H04L 63/1441; H04L 63/1416

(57) ABSTRACT

A dynamic network feature processing device includes a storage device and a processor. The storage device is configured to store a plurality of malicious feature groups. Each of the malicious feature groups corresponds to a malicious feature, and each of the malicious feature groups includes a plurality of malicious network addresses. The processor is coupled to the storage device. The processor is configured to: acquire an unknown network address of an unknown packet; compare the unknown network address with the malicious feature of each of the malicious feature groups; and filter the unknown packet when determining that the unknown network address matches at least one of the malicious feature of the plurality of malicious feature groups.

### CROSS-REFERENCE TO RELATED APPLICATION

This application claims priority to and the benefit of Taiwan Application Serial Number 109137311, filed on Oct. 27, 2020, the entire content of which is incorporated herein by reference as if fully set forth below in its entirety and for all applicable purposes.

### BACKGROUND

### Field of Disclosure

The disclosure generally relates to processing devices and processing methods, and more particularly, to dynamic network feature processing devices and dynamic network feature processing methods.

### Description of Related Art

Data security is an important issue in the wireless communication technique field. One common way that the hacker uses to attack is the denial-of-service attack or called the DoS attack. The hacker attacks some specific target devices, where a large number of malicious packets are sent, such that the target devices consume many network resources and/or computing resources. As the result, the target devices cannot receive and transmit data normally.

Because the target devices suffer from a large number of attacks, the target devices must spend computing resources on attack detection and flow cleaning. However, the data security protection method cannot cover the more complex communication environment for improved network communication technology. The existing data security protection method decreases the network efficiency of the target device, such that the target device cannot decrease the delay time and transmission flow when being attacked. Furthermore, the existing method for detecting the malicious packet is to determine whether the address of the received packet is included in the blacklist by comparing the entire network address. When the target devices are suffering the attacks, it is difficult to compare the address one-by-one and the efficiency is worse in entire address comparison. In addition, the resources of the target devices are consumed unnecessarily.

### SUMMARY

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

The present disclosure of an embodiment provides a dynamic network feature processing device, which includes a storage device and a processor. The storage device is configured to store a plurality of malicious feature groups. Each of the malicious feature groups corresponds to a malicious feature, and each of the malicious feature groups includes a plurality of malicious network addresses. The processor is coupled to the storage device. The processor is configured to: acquire an unknown network address of an unknown packet; compare the unknown network address with the malicious feature of each of the malicious feature groups; and filter the unknown packet when determining that the unknown network address matches at least one of the malicious feature of the plurality of malicious feature groups.

The present disclosure of an embodiment provides a dynamic network feature processing method, which includes the steps of: acquiring an unknown network address of an unknown packet; comparing the unknown network address with a malicious feature of a plurality of malicious feature groups, wherein each of the malicious feature groups comprises a plurality of malicious network addresses; and filtering the unknown packet when determining that the unknown network address matches at least one of the malicious feature of the plurality of malicious feature groups.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as described below. It should be noted that the features in the drawings are not necessarily to scale. The dimensions of the features may be arbitrarily increased or decreased for clarity of discussion.

FIG. 1 is a block diagram illustrating a dynamic network feature processing device according to some embodiments of the present disclosure.

FIG. 2 is a flow chart illustrating a dynamic network feature processing method according to some embodiments of the present disclosure.

FIG. 3 is a flow chart illustrating a dynamic network feature processing method according to some embodiments of the present disclosure.

### DETAILED DESCRIPTION

The technical terms “first”, “second” and similar terms are used to describe elements for distinguishing the same or similar elements or operations and are not intended to limit the technical elements and the order of the operations in the present disclosure. Furthermore, the element symbols/alphabets can be used repeatedly in each embodiment of the present disclosure. The same and similar technical terms can be represented by the same or similar symbols/alphabets in each embodiment. The repeated symbols/alphabets are provided for simplicity and clarity and they should not be interpreted to limit the relation of the technical terms among the embodiments.

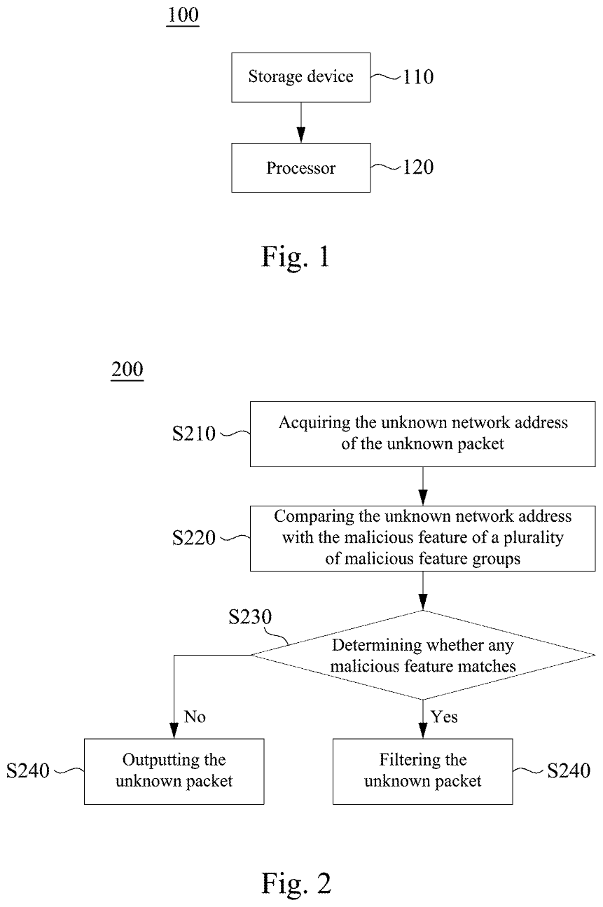

Reference is made to FIG. 1. FIG. 1 is a block diagram illustrating a dynamic network feature processing device 100 according to some embodiments of the present disclosure. The dynamic network feature processing device 100 is disposed in a network architecture for detecting whether any abnormal flow is in the traffic, for example, a malicious packet. In some embodiments, the dynamic network feature processing device 100 includes a storage device 110 and a processor 120. The storage device 110 is coupled with the processor 120.

In some embodiments, the storage device 110 stores a plurality of malicious feature groups. Each of the malicious feature groups corresponds to a malicious feature, and each of the malicious feature groups includes a plurality of malicious network addresses. For more description, reference is made to Table 1. Table 1 shows the malicious feature groups and the corresponding malicious feature.

TABLE 1

| Malicious | | | | | | | | | | | | | | | | | | |
|---|---|---|---|---|---|---|---|---|---|---|---|---|---|---|---|---|---|---|
| feature | | | | | | | | | | | | | | | | | | |
| group | A | B | C | | D | E | | | F | | G | | | H | | | I | J |
| Weight | 4 | 1 | 4 | | 4 | 5 | | | 6 | | 5 | | | 4 | | | 5 | 4 |
| Bit order | 1-3 | 4-6 | 7-8 | 9 | 10-11 | 12-14 | 15 | 16 | 17-19 | 20 | 21-22 | 23 | 24 | 25-26 | 27 | 28 | 29-30 | 31-32 |
| Malicious | 100 | 001 | 00 | X | 10 | 111 | X | X | 000 | X | 11 | X | X | 01 | X | X | 10 | 11 |
| feature | | | | | | | | | | | | | | | | | | |
| (binary) | | | | | | | | | | | | | | | | | | |
| Malicious | The malicious feature of the malicious feature groups which the | | | | | | | | | | | | | | | | | |
| network | malicious feature group corresponds to the malicious network | | | | | | | | | | | | | | | | | |
| address | address | | | | | | | | | | | | | | | | | |
| 140.92.13. | A | | C | | D | E | | | F | | G | | | | | | I | |
| 169 | | | | | | | | | | | | | | | | | | |
| 150.220. | A | | | | D | E | | | F | | G | | | | | | I | J |
| 12.27 | | | | | | | | | | | | | | | | | | |
| 196.141. | | B | C | | | | | | F | | | | | | | | | |
| 18.17 | | | | | | | | | | | | | | | | | | |
| 128.97.51. | A | | C | | | | | | | | | | | H | | | | J |
| 99 | | | | | | | | | | | | | | | | | | |
| 86.221.8. | | | | | D | E | | | F | | | | | | | | | J |
| 19 | | | | | | | | | | | | | | | | | | |
| 127.150. | | | | | | | | | | | G | | | H | | | I | |
| 92.74 | | | | | | | | | | | | | | | | | | |
| 49.92.13. | | | | | D | E | | | F | | G | | | H | | | I | |
| 89 | | | | | | | | | | | | | | | | | | |
| 79.7.254. | | | | | | | | | | | G | | | H | | | | J |
| 103 | | | | | | | | | | | | | | | | | | |
| 132.127.3. | A | | C | | | | | | F | | | | | | | | I | |
| 127 | | | | | | | | | | | | | | | | | | |

In some embodiments, the malicious feature is a binary value. As shown in Table 1, the malicious feature is, according to the bit order (the 1^{st} bit to the 32^{nd} bit), from left to right, “100”, “001”, “00”, “X”, “10”, “111”, “X”, “X”, “000”, “X”, “11”, “X”, “X”, “01”, “X”, “X”, “10”, “11”. In the embodiment, the storage device 110 stores 10 malicious feature groups (the malicious feature group A to J). Each of the malicious feature groups corresponds to one network address bit segment. For example, the malicious feature of the malicious feature group A is “100”, and the malicious feature “110” corresponds to the network address bit segment of the 1^{st} bit to the 3^{rd} bit. The malicious feature of the malicious feature group B is “001”, and the malicious feature “001” corresponds to the network address bit segment of the 4^{th} bit to the 6^{th} bit. On the other hand, the mark “X” of the 9^{th} bit is a don't care bit, which represents that the bit does not the malicious feature of any malicious feature group, and the bit will be ignored while comparing the network address of the unknown packet.

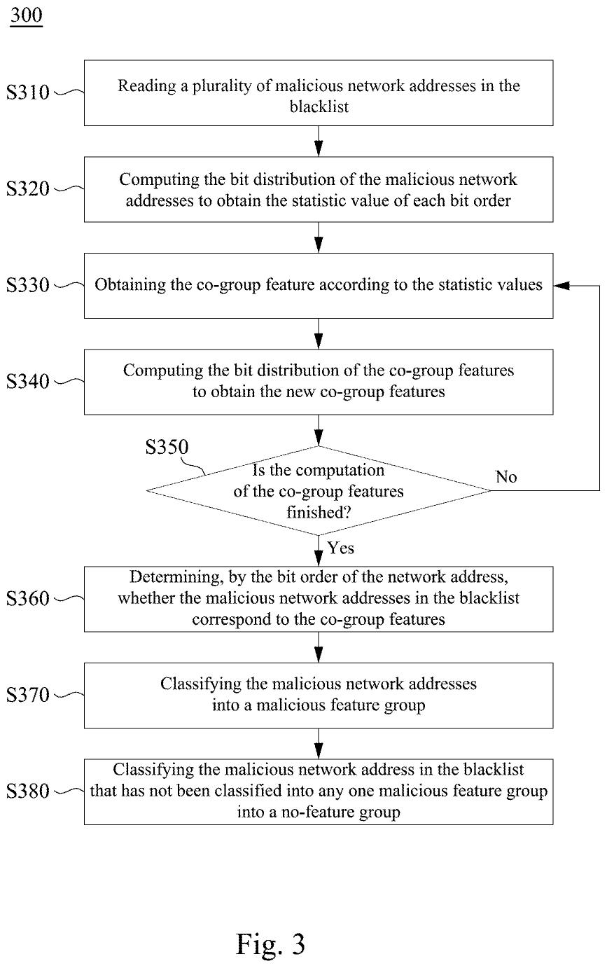

As shown in Table 1, the binary value of the malicious network address 140.92.13.169 is “100” (from the 1^{st} to 3^{rd} bit), “00” (from 4^{th} to 6^{th} bit), “10” (from 10^{th} to 11^{th} bit), “111” (from 12^{th} to 14^{th} bit), “000” (from the 17^{th} to the 19^{th} bit), “11” (from the 21^{st} to the 22^{nd} bit), and “10” (from the 29^{th} to the 30^{th} bit). After the malicious network address, 140.92.13.169, is transformed into the binary value, the binary value is the same as the malicious feature “100” of the malicious feature group A, the malicious feature “00” of the malicious feature group C, the malicious feature “10” of the malicious feature group D, the malicious feature “111” of the malicious feature group E, the malicious feature “000” of the malicious feature group F, the malicious feature “11” of the malicious feature group G, and the malicious feature “10” of the malicious feature group I. In other words, the malicious network address 140.92.13.169 belongs to the malicious feature groups A, C, D, E, F, G, and I. It should be noted that the malicious network addresses in Table 1 are network addresses which are known in a blacklist. The process that classifying the malicious network addresses into which groups will be described in FIG. 3.

In some embodiments, only part of the network address of the packet has to be compared when the dynamic network feature processing device 100 detects whether the unknown packet is a malicious packet. For a detailed description, reference is made to FIG. 2. FIG. 2 is a flow chart illustrating a dynamic network feature processing method 200 according to some embodiments of the present disclosure. The dynamic network feature processing method 200 is configured for determining whether an unknown packet is a malicious packet.

In step S210, acquiring the unknown network address of the unknown packet is performed. In some embodiments, the dynamic network feature processing device 100 acquires the network address of the unknown packet in the traffic and compares the content of each packet to determine whether the packet should be filtered.

In step S220, comparing the unknown network address with the malicious feature of a plurality of malicious feature groups is performed. In some embodiments, the dynamic network feature processing device 100 processes the 32-bit unknown network address, that is, transforms the decimal value into the binary value.

In step S230, determining whether any malicious feature matches is performed. If a determination that any feature of the unknown network address matches the malicious feature, step S240 is performed. If a determination that no feature of the unknown network address matches the malicious feature, step S250 is performed.

The unknown network address, 128.97.51.99, is taken as an example. Reference is made to Table 2. Table 2 is a correlation between the binary value of the unknown network address and the malicious feature groups.

TABLE 2

| Malicious | | | | | | | | | | | | | | | | | | |
|---|---|---|---|---|---|---|---|---|---|---|---|---|---|---|---|---|---|---|
| feature | | | | | | | | | | | | | | | | | | |
| group | A | B | C | | D | E | | | F | | G | | | H | | | I | J |
| Weight | 4 | 1 | 4 | | 4 | 5 | | | 6 | | 5 | | | 4 | | | 5 | 4 |
| Bit order | 1-3 | 4-6 | 7-8 | 9 | 10-11 | 12-14 | 15 | 16 | 17-19 | 20 | 21-22 | 23 | 24 | 25-26 | 27 | 28 | 29-30 | 31-32 |
| (or called | | | | | | | | | | | | | | | | | | |
| as | | | | | | | | | | | | | | | | | | |
| “network | | | | | | | | | | | | | | | | | | |
| address | | | | | | | | | | | | | | | | | | |
| bit | | | | | | | | | | | | | | | | | | |
| segment”) | | | | | | | | | | | | | | | | | | |
| Malicious | 100 | 001 | 00 | X | 10 | 111 | X | X | 000 | X | 11 | X | X | 01 | X | X | 10 | 11 |
| feature | | | | | | | | | | | | | | | | | | |
| (binary) | | | | | | | | | | | | | | | | | | |
| Unknown | 100 | 000 | 00 | 0 | 11 | 000 | 0 | 1 | 001 | 1 | 00 | 1 | 1 | 01 | 1 | 0 | 00 | 11 |
| network | | | | | | | | | | | | | | | | | | |
| address | | | | | | | | | | | | | | | | | | |
| 128.97.51. | | | | | | | | | | | | | | | | | | |
| 99 | | | | | | | | | | | | | | | | | | |
| (binary) | | | | | | | | | | | | | | | | | | |

In some embodiments, the dynamic network feature processing method 200 processes the feature of the unknown network address according to the weight of the malicious feature group, in the order from the large weight to the small weight. In some embodiments, when the weight of the malicious feature group is the same, the process goes on comparing in order of the value of the bit number of the malicious feature of the malicious feature group, from the large number to the small number. For example, as shown in Table 2, the malicious feature group F has the largest weight (whose value is 6). The dynamic network feature processing method 200 compares the features of the bit order 17-19 (or called “network address bit segment”). That is, the malicious feature “000” of the malicious feature group F is compared with the feature “001” of the unknown network address. In the embodiment, the feature of the unknown network address and the malicious feature of the malicious feature group F are mismatched. Then the process goes on comparing the malicious feature of the next weight. In the embodiment, the next weight is 5. The malicious feature group whose weight is 5 includes the malicious feature group E, G, and I. Because the bit number of the malicious feature group E (i.e., 3 bits) is larger than the bit number of the malicious feature group G and I (i.e., 2 bits), the feature of the bit order 12-14 (or called “network address bit segment”) is compared first. That is, the malicious feature “111” of the malicious feature group E is then compared with the feature “000” of the unknown network address.

In some embodiments, the feature of the bit order 1-3 is compared. Because the feature “100” of the unknown network address matches the malicious feature “100” of the malicious feature group A, a determination that the unknown network address 128.97.51.99 is the malicious network address can be made. In other words, the dynamic network feature processing method 200 has only to compare at least one features of the network address bit segment of the unknown network address with the malicious feature of at least one malicious feature group and determine that they match, then the packet of the unknown network address is malicious. Similarly, in the case that the unknown network address is 128.97.51.99, the comparison result is shown in Table 3.

TABLE 3

| Unknown network | The malicious feature group that the unknown network | | | |
|---|---|---|---|---|
| address | address belongs | | | |
| 128.97.51.99 | A | C | H | J |

As shown in Table 3, the feature of the unknown network address 128.97.51.99 matches the malicious feature of the malicious feature groups A, C, H, and J. Then the dynamic network feature processing method 200 determines that the packet of the unknown network address 128.97.51.99 is malicious. The process continues by step S240.

In step S240, filtering the unknown packet is performed. In some embodiments, the unknown packet is dropped.

The unknown network address, 170.172.150.182, is taken as an example. Reference is made to Table 4. Table 4 is a correlation between the binary value of the unknown network address 170.172.150.182 and the malicious feature groups.

TABLE 4

| Malicious | | | | | | | | | | | | | | | | | | |
|---|---|---|---|---|---|---|---|---|---|---|---|---|---|---|---|---|---|---|
| feature | | | | | | | | | | | | | | | | | | |
| group | A | B | C | | D | E | | | F | | G | | | H | | | I | J |
| Weight | 4 | 1 | 4 | | 4 | 5 | | | 6 | | 5 | | | 4 | | | 5 | 4 |
| Bit order | 1-3 | 4-6 | 7-8 | 9 | 10-11 | 12-14 | 15 | 16 | 17-19 | 20 | 21-22 | 23 | 24 | 25-26 | 27 | 28 | 29-30 | 31-32 |
| (or called | | | | | | | | | | | | | | | | | | |
| “network | | | | | | | | | | | | | | | | | | |
| address | | | | | | | | | | | | | | | | | | |
| bit | | | | | | | | | | | | | | | | | | |
| segment) | | | | | | | | | | | | | | | | | | |
| Malicious | 100 | 001 | 00 | X | 10 | 111 | X | X | 000 | X | 11 | X | X | 01 | X | X | 10 | 11 |
| feature | | | | | | | | | | | | | | | | | | |
| (binary) | | | | | | | | | | | | | | | | | | |
| Unknown | 101 | 010 | 10 | 1 | 01 | 011 | 0 | 0 | 100 | 1 | 01 | 1 | 0 | 10 | 1 | 1 | 01 | 10 |
| network | | | | | | | | | | | | | | | | | | |
| address | | | | | | | | | | | | | | | | | | |
| 170.182. | | | | | | | | | | | | | | | | | | |
| 150.182 | | | | | | | | | | | | | | | | | | |
| (binary) | | | | | | | | | | | | | | | | | | |

The dynamic network feature processing method 200 determines whether the unknown network address 170.172.150.182 is a malicious packet according to the determination order: the large weight of the malicious feature group first and/or the large bit number first when their weights are the same. For example, as shown in Table 4, the malicious feature group F has the largest weight (the value is 6). The dynamic network feature processing method 200 compares the feature of the bit order 17-19. That is, the malicious feature “000” of the malicious feature group F is compared with the feature “100” of the unknown network address. The feature “100” of the unknown network address and the malicious feature “000” of the malicious feature group F are mismatched. Then the malicious feature of the next weight is taken for examination. Similarly, the comparison result of the unknown network address 170.172.150.182 is shown in Table 5.

TABLE 5

| Unknown | The malicious feature group that the unknown network address | | | | | | | | | |
|---|---|---|---|---|---|---|---|---|---|---|
| network address | belongs | | | | | | | | | |
| Malicious | A | B | C | D | E | F | G | H | I | J |
| feature group | | | | | | | | | | |
| 170.172.150.182 | miss | miss | miss | miss | miss | miss | miss | miss | miss | miss |

In the embodiment, no features of the unknown network address 170.172.150.182 matches the malicious feature group. In other words, the unknown network address 170.172.150.182 is not malicious packet. Then the process continues by step S250.

In step S250, outputting the unknown packet is performed. In some embodiments, the unknown packet is forwarded to the destination instead of being dropped.

Reference is made to FIG. 3. FIG. 3 is a flow chart illustrating a dynamic network feature processing method 300 according to some embodiments of the present disclosure. The dynamic network feature processing method 300 is configured for computing a plurality of malicious feature groups by a plurality of malicious network addresses in a blacklist. The dynamic network feature processing method 300 classified the malicious network addresses in the blacklist into feature groups and dynamic space splitting to acquire malicious features from the malicious network addresses and to classify the malicious features into groups, and then the malicious feature groups in Table 1 can be obtained.

In step S310, reading a plurality of malicious network addresses in the blacklist is performed. In some embodiments, the blacklist is the list that includes the malicious network addresses prepared in advance.

In step S320, computing the bit distribution of the malicious network addresses to obtain the statistic value of each bit order is performed. Reference is made to Table 6. Table 6 shows 6 malicious network addresses and the 32-bit binary value of the malicious network address.

TABLE 6

| Malicious | | Bit order | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|---|---|
| network address | | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 | 28 | 29 | 30 | 31 | 32 |
| 140.92.13.169 | | 1 | 0 | 0 | 0 | 1 | 1 | 0 | 0 | 0 | 1 | 0 | 1 | 1 | 1 | 0 | 0 | 0 | 0 | 0 | 0 | 1 | 1 | 0 | 1 | 1 | 0 | 1 | 0 | 1 | 0 | 0 | 1 |
| 150.220.12.27 | | 1 | 0 | 0 | 1 | 0 | 1 | 1 | 0 | 1 | 1 | 0 | 1 | 1 | 1 | 0 | 0 | 0 | 0 | 0 | 0 | 1 | 1 | 0 | 0 | 0 | 0 | 0 | 1 | 1 | 0 | 1 | 1 |
| 196.141.18.17 | | 1 | 1 | 0 | 0 | 0 | 1 | 0 | 0 | 1 | 0 | 0 | 0 | 1 | 1 | 0 | 1 | 0 | 0 | 0 | 1 | 0 | 0 | 1 | 0 | 0 | 0 | 0 | 1 | 0 | 0 | 0 | 1 |
| 128.97.51.99 | | 1 | 0 | 0 | 0 | 0 | 0 | 0 | 0 | 0 | 1 | 1 | 0 | 0 | 0 | 0 | 1 | 0 | 0 | 1 | 1 | 0 | 0 | 1 | 1 | 0 | 1 | 1 | 0 | 0 | 0 | 1 | 1 |
| 86.221.8.19 | | 0 | 1 | 0 | 1 | 0 | 1 | 1 | 0 | 1 | 1 | 0 | 1 | 1 | 1 | 0 | 1 | 0 | 0 | 0 | 0 | 1 | 0 | 0 | 0 | 0 | 0 | 0 | 1 | 0 | 0 | 1 | 1 |
| 127.150.92.74 | | 0 | 1 | 1 | 1 | 1 | 1 | 1 | 1 | 1 | 0 | 0 | 1 | 0 | 1 | 1 | 0 | 0 | 1 | 0 | 1 | 1 | 1 | 0 | 0 | 0 | 1 | 0 | 0 | 1 | 0 | 1 | 0 |
| 49.92.13.89 | | 0 | 0 | 1 | 1 | 0 | 0 | 0 | 1 | 0 | 1 | 0 | 1 | 1 | 1 | 0 | 0 | 0 | 0 | 0 | 0 | 1 | 1 | 0 | 1 | 0 | 1 | 0 | 1 | 1 | 0 | 0 | 1 |
| 79.7.254.103 | | 0 | 1 | 0 | 0 | 1 | 1 | 1 | 1 | 0 | 0 | 0 | 0 | 0 | 1 | 1 | 1 | 1 | 1 | 1 | 1 | 1 | 1 | 1 | 0 | 0 | 1 | 1 | 0 | 0 | 1 | 1 | 1 |
| 132.127.3.217 | | 1 | 0 | 0 | 0 | 0 | 1 | 0 | 0 | 0 | 1 | 1 | 1 | 1 | 1 | 1 | 1 | 0 | 0 | 0 | 0 | 0 | 1 | 1 | 1 | 1 | 1 | 0 | 1 | 1 | 0 | 0 | 1 |
| Statistic | 1 | 5 | 4 | 2 | 4 | 3 | 7 | 4 | 3 | 4 | 6 | 2 | 6 | 6 | 8 | 3 | 5 | 1 | 2 | 2 | 4 | 6 | 6 | 4 | 4 | 2 | 5 | 3 | 5 | 5 | 1 | 5 | 8 |
| value | 0 | 4 | 5 | 7 | 5 | 6 | 2 | 5 | 6 | 5 | 3 | 7 | 3 | 3 | 1 | 6 | 4 | 8 | 7 | 7 | 5 | 3 | 3 | 5 | 5 | 7 | 4 | 6 | 4 | 4 | 8 | 4 | 1 |
| Co-group | | 1 | 0 | 0 | 0 | 0 | 1 | 0 | 0 | 0 | 1 | 0 | 1 | 1 | 1 | 0 | 1 | 0 | 0 | 0 | 0 | 1 | 1 | 0 | 0 | 0 | 1 | 0 | 1 | 1 | 0 | 1 | 1 |
| feature | | | | | | | | | | | | | | | | | | | | | | | | | | | | | | | | | |
| (or called | | | | | | | | | | | | | | | | | | | | | | | | | | | | | | | | | |
| “representative | | | | | | | | | | | | | | | | | | | | | | | | | | | | | | | | | |
| value”) | | | | | | | | | | | | | | | | | | | | | | | | | | | | | | | | | |

In some embodiments, the dynamic network feature processing method 300 computes the bit distribution of each bit order. That is, the statistic value of each bit order which is 1 or 0 is computed. As shown in Table 6, among the malicious network addresses, the statistic value that the value of the first bit is 1 is 5, and the statistic value that the value of the first bit is 0 is 4. The dynamic network feature processing method 300 takes the large statistic value and sets the value as a co-group feature (or called a “representative value”). Hence, the representative value of the first bit is 1, and so on.

In step S330, obtaining the co-group feature according to the statistic values is performed. In some embodiments, the dynamic network feature processing method 300 determines which value is large between the statistic value of the left bit and the statistic value of the right bit of each bit (of the malicious network address) to tag a co-group sign on the large value. For example, as shown in Table 6, the statistic value of the left bit of the second bit (of the malicious network address), that is the first bit, is 4, and the statistic value of the right bit of the second bit (that is, the third bit) is 7. Because the statistic value of the third bit, 7, is larger than the statistic value of the first bit, 4, the second bit is made a co-group sign to the right bit (the third bit). Similarly, the statistic value of the left bit of the third bit, that is the second bit, is 5, and the statistic value of the right bit of the third bit (that is the fourth bit) is 5. Because the statistic value of the second bit, 5, is equal to the statistic value of the fourth bit, in the case, the third bit is made the co-group sign to the left bit in default. Hence, the third bit is made the co-group sign to the left bit (the second bit). Similarly, each bit of the malicious network address is made the co-group sign to the left bit or the right bit.

Then, the dynamic network feature processing method 300 merges the bits which are made the co-group sign to each other and sets the bits which are made the co-group sign to each other into the same one group. As described above, the second bit and the third bit are made the co-group sign o each other. Then the second bit (whose feature is 0) and the third bit (whose feature is 0) are set into the same one group. Similarly, the bits which are set into the same one group are the co-group feature. For example, after the second bit and the third bit are merged, the co-group feature is “00”. Reference is made to Table 7, which illustrates the co-group feature after all the malicious network addresses of the blacklist are made the co-group sign.

TABLE 7

| Malicious | Bit order | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|---|
| network address | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 | 28 | 29 | 30 | 31 | 32 |

| | | | | | | | | | | | | | | | | | | | | | | | | | | |
|---|---|---|---|---|---|---|---|---|---|---|---|---|---|---|---|---|---|---|---|---|---|---|---|---|---|---|
| 140.92.13.169 | 1 | 00 | 0 | 1 | 1 | 0 | 0 | 0 | 10 | 1 | 11 | 0 | 0 | 00 | 0 | 0 | 11 | 0 | 1 | 1 | 0 | 1 | 0 | 10 | 0 | 1 |

| 150.220.12.27 | 1 | 00 | | 1 | 01 | 1 | 0 | 1 | 10 | | 1 | 11 | 0 | 0 | 00 | 0 | 0 | 11 | | 0 | 0 | 0 | 0 | 0 | 1 | 10 | | 11 | |
|---|---|---|---|---|---|---|---|---|---|---|---|---|---|---|---|---|---|---|---|---|---|---|---|---|---|---|---|---|---|
| 196.141.18.17 | 1 | 1 | 0 | 0 | 01 | 0 | 0 | 1 | 0 | 0 | 0 | 11 | 0 | 1 | 00 | 0 | 1 | 0 | 0 | 1 | 0 | 0 | 0 | 0 | 1 | 0 | 0 | 0 | 1 |

| | | | | | | | | | | | | | | | | | | | | | | | | | | | | |
|---|---|---|---|---|---|---|---|---|---|---|---|---|---|---|---|---|---|---|---|---|---|---|---|---|---|---|---|---|
| 128.97.51.99 | 1 | 00 | 0 | 0 | 0 | 0 | 0 | 0 | 1 | 1 | 0 | 0 | 0 | 0 | 1 | 00 | 1 | 1 | 0 | 0 | 1 | 1 | 01 | 1 | 0 | 0 | 0 | 11 |

| | | | | | | | | | | | | | | | | | | | | | | | | | | | |
|---|---|---|---|---|---|---|---|---|---|---|---|---|---|---|---|---|---|---|---|---|---|---|---|---|---|---|---|
| 86.221.8.19 | 0 | 1 | 0 | 1 | 01 | 1 | 0 | 1 | 10 | 1 | 11 | 0 | 1 | 00 | 0 | 0 | 1 | 0 | 0 | 0 | 0 | 0 | 0 | 1 | 0 | 0 | 11 |

| | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|
| 127.150.92.74 | 0 | 1 | 1 | 1 | 1 | 1 | 1 | 1 | 1 | 0 | 0 | 1 | 0 | 1 | 1 | 0 | 0 | 1 | 0 | 1 | 11 | 0 | 0 | 01 | 0 | 0 | 10 | 1 | 0 |
| 49.92.13.89 | 0 | 0 | 1 | 1 | 0 | 0 | 0 | 1 | 0 | 1 | 0 | 1 | 1 | 1 | 0 | 0 | 0 | 0 | 0 | 0 | 11 | 0 | 1 | 01 | 0 | 1 | 10 | 0 | 1 |

| | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|
| 79.7.254.103 | 0 | 1 | 0 | 0 | 1 | 1 | 1 | 1 | 0 | 0 | 0 | 0 | 0 | 1 | 1 | 1 | 1 | 1 | 1 | 1 | 11 | 1 | 0 | 01 | 1 | 0 | 0 | 1 | 11 |

| | | | | | | | | | | | | | | | | | | | | | | | | | | | |
|---|---|---|---|---|---|---|---|---|---|---|---|---|---|---|---|---|---|---|---|---|---|---|---|---|---|---|---|
| 132.127.3.217 | 1 | 00 | 0 | 01 | 0 | 0 | 0 | 1 | 1 | 1 | 11 | 1 | 1 | 00 | 0 | 0 | 0 | 1 | 1 | 1 | 1 | 1 | 0 | 1 | 10 | 0 | 1 |

As shown in Table 7, the content of each entry in the table is the co-group feature.

In step S340, computing the bit distribution of the co-group features to obtain the new co-group features is performed. In some embodiments, the dynamic network feature processing method 300 computes the bit distribution of each bit order or the bit distribution of each bit segment. For example, as shown in Table 8, Table 8 shows the statistic value of each bit order and the co-group feature of each bit order.

TABLE 8

| Malicious | | Bit order | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|---|---|
| network address | | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 | 28 | 29 | 30 | 31 | 32 |
| 140.92.13.169 | | 1 | 00 | | 0 | 1 | 1 | 0 | 0 | 0 | 10 | | 1 | 11 | | 0 | 0 | 00 | | 0 | 0 | 11 | | 0 | 1 | 1 | 0 | 1 | 0 | 10 | | 0 | 1 |
| 150.220.12.27 | | 1 | 00 | | 1 | 01 | | 1 | 0 | 1 | 10 | | 1 | 11 | | 0 | 0 | 00 | | 0 | 0 | 11 | | 0 | 0 | 0 | 0 | 0 | 1 | 10 | | 11 | |
| 196.141.18.17 | | 1 | 1 | 0 | 0 | 01 | | 0 | 0 | 1 | 0 | 0 | 0 | 11 | | 0 | 1 | 00 | | 0 | 1 | 0 | 0 | 1 | 0 | 0 | 0 | 0 | 1 | 0 | 0 | 0 | 1 |
| 128.97.51.99 | | 1 | 00 | | 0 | 0 | 0 | 0 | 0 | 0 | 1 | 1 | 0 | 0 | 0 | 0 | 1 | 00 | | 1 | 1 | 0 | 0 | 1 | 1 | 01 | | 1 | 0 | 0 | 0 | 11 | |
| 86.221.8.19 | | 0 | 1 | 0 | 1 | 01 | | 1 | 0 | 1 | 10 | | 1 | 11 | | 0 | 1 | 00 | | 0 | 0 | 1 | 0 | 0 | 0 | 0 | 0 | 0 | 1 | 0 | 0 | 11 | |
| 127.150.92.74 | | 0 | 1 | 1 | 1 | 1 | 1 | 1 | 1 | 1 | 0 | 0 | 1 | 0 | 1 | 1 | 0 | 0 | 1 | 0 | 1 | 11 | | 0 | 0 | 01 | | 0 | 0 | 10 | | 1 | 0 |
| 49.92.13.89 | | 0 | 0 | 1 | 1 | 0 | 0 | 0 | 1 | 0 | 1 | 0 | 1 | 1 | 1 | 0 | 0 | 0 | 0 | 0 | 0 | 11 | | 0 | 1 | 01 | | 0 | 1 | 10 | | 0 | 1 |
| 79.7.254.103 | | 0 | 1 | 0 | 0 | 1 | 1 | 1 | 1 | 0 | 0 | 0 | 0 | 0 | 1 | 1 | 1 | 1 | 1 | 1 | 1 | 11 | | 1 | 0 | 01 | | 1 | 0 | 0 | 1 | 11 | |
| 132.127.3.217 | | 1 | 00 | | 0 | 01 | | 0 | 0 | 0 | 1 | 1 | 1 | 11 | | 1 | 1 | 00 | | 0 | 0 | 0 | 1 | 1 | 1 | 1 | 1 | 0 | 1 | 10 | | 0 | 1 |
| Statistic | 1 | 5 | 4 | 2 | 4 | 3 | 7 | 4 | 3 | 4 | 6 | 2 | 6 | 6 | 8 | 3 | 5 | 1 | 2 | 2 | 4 | 6 | 6 | 4 | 4 | 2 | 5 | 3 | 5 | 5 | 1 | 5 | 8 |
| value | 0 | 4 | 5 | 7 | 5 | 6 | 2 | 5 | 6 | 5 | 3 | 7 | 3 | 3 | 1 | 6 | 4 | 8 | 7 | 7 | 5 | 3 | 3 | 5 | 5 | 7 | 4 | 6 | 4 | 4 | 8 | 4 | 1 |
| | 00 | | 4 | | | | | | | | | | | | | | | 7 | | | | | | | | | | | | | | | |
| | 01 | | | | | 4 | | | | | | | | | | | | | | | | | | | | 4 | | | | | | | |
| | 10 | | | | | | | | | | 4 | | | | | | | | | | | | | | | | | | | 5 | | | |
| | 11 | | | | | | | | | | | | | 6 | | | | | | | | 5 | | | | | | | | | | 4 | |
| Co-group | | 1 | 00 | | 0 | 01 | | 0 | 0 | 0 | 10 | | 1 | 11 | | 0 | 1 | 00 | | 0 | 0 | 11 | | 0 | 0 | 01 | | 0 | 1 | 0 | | 11 | |
| feature | | | | | | | | | | | | | | | | | | | | | | | | | | | | | | | | | |

In step S350, determining whether the computation of the co-group features is finished is performed. In some embodiments, if the dynamic network feature processing method 300 does not finish computing the co-group features, the process goes back to step S330, setting the co-group sign of the left and the right bit to find the final co-group features is performed.

In some embodiments, the co-group features finally obtained are shown in Table 9. For example, the co-group feature of the first bit to the third bit is “100”. The weight of the co-group feature of each bit order is the statistic value that all the malicious network addresses of the bit order have the same statistic value.

TABLE 9

| Bit order | 1-3 | 4-6 | 7-8 | 9 | 10-11 | 12-14 | 15 | 16 | 17-19 | 20 | 21-22 | 23 | 24 | 25-26 | 27 | 28 | 29-30 | 31-32 |
|---|---|---|---|---|---|---|---|---|---|---|---|---|---|---|---|---|---|---|
| Co-group | 100 | 001 | 00 | X | 10 | 111 | X | X | 000 | X | 11 | X | X | 01 | X | X | 10 | 11 |
| feature | | | | | | | | | | | | | | | | | | |
| (binary) | | | | | | | | | | | | | | | | | | |
| Weight | 4 | 1 | 4 | | 4 | 5 | | | 6 | | 5 | | | 4 | | | 5 | 4 |

In some embodiments, if the dynamic network feature processing method 300 determines that the computation of the co-group features is finished, the process goes to step S360 to compare the co-group features which are trained to determine whether the co-group features correspond to the malicious network addresses in the blacklist. This is a confirmation step to determine whether any malicious network address in the blacklist does not correspond to the trained result.

In step S360, determining, by the bit order of the network address, whether the malicious network addresses in the blacklist correspond to the co-group features is performed. In some embodiments, the malicious network addresses are compared with the co-group features in the binary form. In some embodiments, the co-group features in Table 9 computed in step S310 to step S370 are the malicious features in Table 2 described above.

In step S370, classifying the malicious network addresses into a malicious feature group is performed. As shown in Table 10, the malicious features that the malicious network address in the blacklist matches are represented below.

TABLE 10

| | Malicious feature group A to J and the malicious feature of each | | | | | | | | | | | | | | | | | |
|---|---|---|---|---|---|---|---|---|---|---|---|---|---|---|---|---|---|---|
| Malicious | malicious feature group which the malicious network address belongs | | | | | | | | | | | | | | | | | |
| network | A | B | C | | D | E | | | F | | G | | | H | | | I | J |
| address | 100 | 001 | 00 | X | 10 | 111 | X | X | 000 | X | 11 | X | X | 01 | X | X | 10 | 11 |
| 140.92.13.169 | A | | C | | D | E | | | F | | G | | | | | | I | |
| 150.220.12.27 | A | | | | D | E | | | F | | G | | | | | | I | J |
| 196.141.18.17 | | B | C | | | | | | F | | | | | | | | | |
| 128.97.51.99 | A | | C | | | | | | | | | | | H | | | | J |
| 86.221.8.19 | | | | | D | E | | | F | | | | | | | | | J |
| 127.150.92.74 | | | | | | | | | | | G | | | H | | | I | |
| 49.92.13.89 | | | | | D | E | | | F | | G | | | H | | | I | |
| 79.7.254.103 | | | | | | | | | | | G | | | H | | | | J |
| 132.127.3.127 | A | | C | | | | | | F | | | | | | | | I | |

For example, the first bit to the third bit of the malicious network address 140.92.13.169 is “100”, which matches the malicious feature “100” of the malicious feature group A. Hence, the malicious network address 140.92.13.169 is classified into the malicious feature group A. Similarly, the malicious network addresses that the malicious feature groups A to J include are shown in Table 11.

TABLE 11

| Malicious | Malicious |
|---|---|
| feature | network |
| group | address |
| A | 140.92.13.169 |
| | 150.220.12.27 |
| | 128.97.51.99 |
| | 132.127.3.127 |
| B | 196.141.18.17 |
| C | 140.92.13.169 |
| | 196.141.18.17 |
| | 128.97.51.99 |
| | 132.127.3.127 |
| D | 140.92.13.169 |
| | 150.220.12.27 |
| | 86.221.8.19 |
| | 49.92.13.89 |
| E | 140.92.13.169 |
| | 150.220.12.27 |
| | 86.221.8.19 |
| | 49.92.13.89 |
| F | 140.92.13.169 |
| | 150.220.12.27 |
| | 196.141.18.17 |
| | 86.221.8.19 |
| | 49.92.13.89 |
| | 132.127.3.127 |
| G | 140.92.13.169 |
| | 150.220.12.27 |
| | 127.150.92.74 |
| | 49.92.13.89 |
| | 79.7.254.103 |
| H | 128.97.51.99 |
| | 127.150.92.74 |
| | 49.92.13.89 |
| | 79.7.254.103 |
| I | 140.92.13.169 |
| | 150.220.12.27 |
| | 127.150.92.74 |
| | 49.92.13.89 |
| | 132.127.3.127 |
| J | 150.220.12.27 |
| | 128.97.51.99 |
| | 86.221.8.19 |
| | 79.7.254.103 |

In step S380, classifying the malicious network address in the blacklist that has not been classified into any one malicious feature group into a no-feature group is performed. In some embodiments, there may be some malicious network addresses that have not been classified into any malicious feature groups in Table 11. For confirming that all the malicious network addresses in the blacklist can be referred to, the dynamic network feature processing method 300 classifies the malicious network address that has not been classified into any one malicious feature group into the no-feature group.

In some embodiments, reference is made to FIG. 2. When the dynamic network feature processing method 200 acquires the network address of the unknown packet, the unknown network address is compared with the malicious features of the malicious feature groups A to J. If the comparison result shows that no malicious feature matches, the unknown network address is further compared with the malicious feature of the no-feature group to prevent the omission from comparisons.

In some embodiments, as shown in FIG. 1, the processor 120 may be a conventional processor, a general purpose processor, a special purpose processor, a digital signal processor (DSP), Application Specific Integrated Circuits (ASICs), Field Programmable Gate Array (FPGAs) circuits, and the like. The dynamic network feature processing device 100 of the present disclosure can be, but is not limited to, the communication network devices. The dynamic network feature processing device 100 may communicate via various networks including WLAN, WPAN (e.g., Bluetooth, Zigbee), cellular, wireline.

As described above, the dynamic network feature processing device and the dynamic network feature processing method in the present disclosure do not compare the entire network address when determining whether the address of the unknown packet is the malicious network address. Instead, only part of the address is needed for comparisons and the determination result can be made. On the other hand, no need for comparing all the addresses of the unknown packet with all the malicious network addresses in the blacklist. Only part of the unknown network address is determined to match with one of the malicious feature group, and the unknown packet can be determined to be a malicious packet and then is dropped. In contrast with the prior art that not only all the addresses in the blacklist but also the entire length of the address in the blacklist has to be compared with, in the present disclosure, only each one malicious feature should be compared with to determine whether the unknown packet is malicious. Accordingly, the present disclosure can enhance the processing efficiency when the network devices are attacked, and a large number of computing resources can be saved from malicious attacking.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A dynamic network feature processing device, comprising:
a storage device configured to store a plurality of malicious feature groups, wherein each of the malicious feature groups corresponds to a malicious feature, each of the malicious feature groups comprises a plurality of malicious network addresses; and
a processor coupled to the storage device, wherein the processor is configured to:
acquire an unknown network address of an unknown packet;
compare the unknown network address with the malicious feature of each of the malicious feature groups; and
filter the unknown packet when determining that the unknown network address matches at least one of the malicious feature of the plurality of malicious feature groups.

2. The dynamic network feature processing device of claim 1, wherein the processor is further configured to:
read a blacklist, wherein the blacklist comprises the malicious network addresses; and
compute, for a plurality of bit values of the malicious network addresses, the malicious feature of the malicious feature groups according to a bit order.

3. The dynamic network feature processing device of claim 1, wherein the malicious feature of each of the malicious feature groups is part of the malicious network addresses.

4. The dynamic network feature processing device of claim 1, wherein the plurality of malicious feature groups comprises a first group and a second group, and the malicious feature of the first group corresponds to a first network address bit segment, wherein the processor is further configured to:
compare the malicious feature of the first group with the unknown network address of the first network address bit segment; and
filter the unknown packet when determining that the unknown network address of the first network address bit segment matches the malicious feature of the first group.

5. The dynamic network feature processing device of claim 4, wherein the malicious feature of the second group corresponds to a second network address bit segment, and the first network address bit segment is different from the second network address bit segment, wherein the processor is further configured to:
compare the malicious feature of the second group with the unknown network address of the second network address bit segment when determining that the unknown network address of the first network address bit segment and the malicious feature of the first group are mismatched; and
filter the unknown packet when determining that the unknown network address of the second network address bit segment matches the malicious feature of the second group.

6. The dynamic network feature processing device of claim 5, wherein the processor is further configured to:
output the unknown packet when determining that the unknown network address of the second network address bit segment and the malicious feature of the second group are mismatched.

7. A dynamic network feature processing method, comprising:
acquiring an unknown network address of an unknown packet;
comparing the unknown network address with a malicious feature of a plurality of malicious feature groups, wherein each of the malicious feature groups comprises a plurality of malicious network addresses; and
filtering the unknown packet when determining that the unknown network address matches at least one of the malicious feature of the plurality of malicious feature groups.

8. The dynamic network feature processing method of claim 7, further comprising:
reading a blacklist, wherein the blacklist comprises the malicious network addresses; and
computing, for a plurality of bit values of the malicious network addresses, the malicious feature of the malicious feature groups according to a bit order.

9. The dynamic network feature processing method of claim 7, wherein the malicious feature of each of the malicious feature groups is part of the malicious network addresses.

10. The dynamic network feature processing method of claim 7, wherein the plurality of malicious feature groups comprises a first group and a second group, and the malicious feature of the first group corresponds to a first network address bit segment, and the dynamic network feature processing method further comprises:
comparing the malicious feature of the first group with the unknown network address of the first network address bit segment; and
filtering the unknown packet when determining that the unknown network address of the first network address bit segment matches the malicious feature of the first group.

11. The dynamic network feature processing method of claim 10, wherein the malicious feature of the second group corresponds to a second network address bit segment, and the first network address bit segment is different from the second network address bit segment, and the dynamic network feature processing method further comprises:
comparing the malicious feature of the second group with the unknown network address of the second network address bit segment when determining that the unknown network address of the first network address bit segment and the malicious feature of the first group are mismatched; and
filtering the unknown packet when determining that the unknown network address of the second network address bit segment matches the malicious feature of the second group.

12. The dynamic network feature processing method of claim 11, further comprising:
outputting the unknown packet when determining that the unknown network address of the second network address bit segment and the malicious feature of the second group are mismatched.
